(19) United States
(12) Patent Application Publication
(10) Pub. No.: US 2006/0229183 A1
(43) Pub. Date: Oct. 12, 2006

(54) Bi-material closure device for a bag

(76) Inventor: Henri Bois, Neuilly Sur Seine (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/399,794

(22) Filed: Apr. 7, 2006

(30) Foreign Application Priority Data
Apr. 8, 2005 (FR) 0503516

(51) Int. Cl. B31B 1/52

(52) U.S. Cl. 493/457

(57) ABSTRACT

This present invention concerns a closure assembly that includes two complementary zippers, respectively with support backing-strips (220) and complementary closure elements (242), characterised by the fact that at least one of these closure elements includes a widened soleplate (246) that is at least partially surrounded by the associated support backing-strip (220).

This present invention concerns the area of closure zippers designed to perform multiple opening and closing of bags.

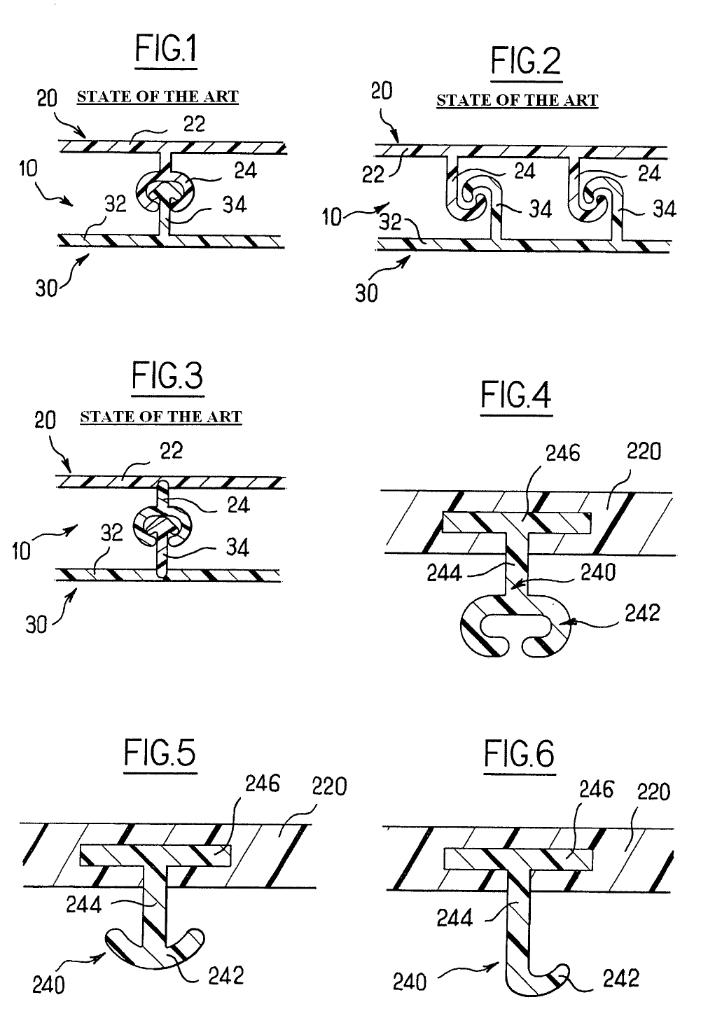

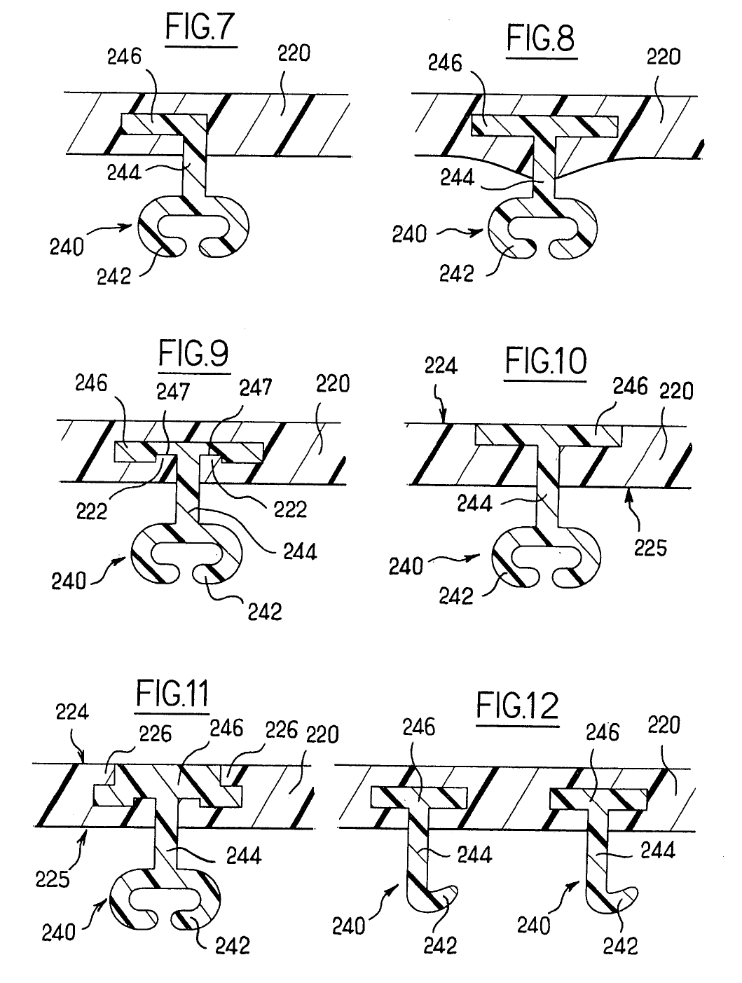

FIGS. 1 and 2 show an example of known closure zippers.

These two figures respectively show two closure assemblies 10 each with two complementary zippers 20, 30.

More precisely these two assemblies 10 each have two zippers 20, 30 that include support backing-strips 22, 32 which carry complementary closure elements 24, 34. According to FIG. 1, these elements 24, 34 are formed from complementary male/female structures. According to FIG. 2, these elements 24, 34 are formed from complementary hooks.

Many closure zippers of the type shown in FIGS. 1 and 2 have already been proposed.

Generally, these closure zippers are extrusions made from thermoplastic materials.

However it is proving desirable now, for certain applications, to have bi-material closure zippers, meaning zippers in which the backing-strips 20, 30 and the closure elements 24, 34 are made from different materials. In theory, this should enable one to create closure assemblies that have, for example, different colours or even different degrees of flexibility between the backing-strips 20, 30 and the associated closure elements 24, 34. To this end, an attempt has been made to co-extrude backing-strips 20, 30 and closure elements 24, 34 made from different materials, as shown diagrammatically in FIG. 3 attached, for closure elements 24, 34 of the male/female type.

Up to now however, these attempts have not given total satisfaction. In fact, they present a persistent risk of separation of the closure elements 24, 34 in relation to the support backing-strips 20, 30 when the bags pulled open, or again under the simple effect of pressure inside the bag.

In this context, this present invention has as its objective to perfect the existing resources.

This objective is attained in the context of this present invention by virtue of a closure assembly that includes two complementary zippers respectively with support backing-strips and complementary closure elements, characterised by the fact that at least one of these closure elements includes a widened soleplate which is at least partially surrounded by the associated support backing-strip.

The professional engineer will understand that this arrangement enables the closure element to be retained on the support backing-strip, thereby eliminating any risk of separation between the closure element and the associated support backing-strip.

Other characteristics, objectives and advantages of this present invention will appear on reading the detailed description that follows, with reference to the appended drawings, provided by way of non-limiting examples and in which:

FIGS. 1 to 3, described previously, represent closure assemblies according to existing designs,

FIG. 4 is a view in cross-section of a closure zipper according to this present invention, and

FIGS. 5 to 12 represent diverse variants for the creation of closure zippers according to this present invention.

FIG. 4 shows a closure zipper according to this present invention that includes a closure element 240 of the female type that has a channel 242 with converging edges connected to a rod 244 which is generally perpendicular to the main surfaces of a support backing-strip 220. According to the invention, the rod 244 is equipped, at the end opposite to the channel 242 with converging edges, with a widened soleplate 246 embedded in the mass of the backing-strip 220. In other words the soleplate 246 is totally surrounded by the material of the backing-strip 220. It is located in a cavity formed in the thickness of the backing-strip 220.

Preferably, the backing-strip 220 and the associated closure element 240 shown in FIG. 4 are co-extruded in thermoplastic materials.

The technique of co-extrusion is well known to the professional engineer. It will therefore not be described in detail in what follows.

FIGS. 5 and 6 show two variants for the creation of closure zippers according to this present invention, which differ from the zipper shown in FIG. 4 only by the fact that the closure element 240 is composed of an element 242 of the male type in FIG. 5 and an element of the hook type in FIG. 6.

The soleplate 246 lies symmetrically on either side of the rod 244 according to the variants shown in FIGS. 4 to 6.

On the other hand, according to the variant shown in FIG. 7, the soleplate 246 is asymmetrical in relation to the rod 244. More precisely, according to FIG. 7, it lies only on one side of the rod 244. According to yet another variant, not shown in the figures so as to simplify the illustration, the soleplate 246 could lie on either side of the rod 244, but along different extensions.

FIG. 8 shows another implementation variant according to which the support backing-strip 220 has a variable thickness at the location of the soleplate 246. More precisely, again according to the implementation variant shown in FIG. 8, the backing-strip 220 has an increasing thickness close to the rod 244. This arrangement is used to strengthen the retention of the closure element 240 on the support backing-strip 220.

As shown in FIG. 9, where appropriate, structures of complementary shape can be provided, interleaved between the backing-strip 220 and the soleplate 246 in order to reinforce the retention of the closure element 240. More precisely, again according to the method of implementation shown in FIG. 9, at least one low ridge 222 is provided, cast in the material of the support backing-strip 220 and engaged in a complementary channel 247 formed in the soleplate 246. According to FIG. 9, two such low parallel ridges 222 are provided, respectively adjacent to the rod 244 on either side of the latter.

According to the implementation variant shown in FIG. 10 the soleplate 246 is accessible on the face 224 of the support backing-strip 220 opposite to the face 225 of this support backing-strip by which the rod 244 bearing the closure element 242 emerges.

FIG. 11 shows a variant according to which the soleplate 246 emerges on the face 224 of the support backing-strip opposite to the closure element 242. However, according to the variant shown in FIG. 11, at the level of this face 224 of the support backing-strip 220, the soleplate 246 is partially covered by ribs 226 cast in the material of the support backing-strip 220. This arrangement is used to eliminate the risk of extraction of the soleplate 246 via the face 224 of the support backing-strip 220.

For the hook-type closure elements, FIG. 12 shows that this present invention can apply to support backing-strips 220 that have several closure elements in parallel.

It will be seen that the characteristics of this present invention, according to which at least one of the closure elements includes a soleplate that is at least partially embedded in a support backing-strip, applies either to the creation of closure assemblies as such that are intended to be assembled later and secured onto a film, by welding for example, or to closure assemblies that are directly integrated by extrusion in films that are intended for the design of bags.

This present invention applies in particular to closure assemblies in which the support backing-strips 220 and closure elements 240 are made from different thermoplastic materials. This arrangement is used, for example, to create a support backing-strip 220 and an associated closure assembly 240 in different colours or with different degrees of flexibility.

In this context, the materials making up the support backing-strip 220 and the closure element 240 are advantageously chosen from the group that includes polyethylene, polypropylene and polystyrene.

More precisely and again preferably, according to the invention, the support backing-strip and the associated closure element 240 matching the configurations described previously are preferably chosen from the pairs that include polyethylene and polypropylene or polyethylene and polystyrene.

The implementation variants shown in FIGS. 7 to 11 are illustrated with a closure element 242 of the female type. However the invention is not limited to this arrangement. All the characteristics shown in FIGS. 7 to 11, as well as those illustrated in FIG. 12, are liable of be applied to any type of closure element 242 whether of the female, male or hook type or any other equivalent shape.

In addition, the invention also covers any combination of the characteristics described previously and shown in the appended figures.

1. A closure assembly that has two complementary zippers which respectively include support backing-strips (220) and complementary closure elements (242), characterised by the fact that at least one of these closure elements includes a widened soleplate (246) at least partially surrounded by the associated support backing-strip (220).

2. An assembly according to claim 1, characterised by the fact that the closure element (242) is chosen from the group that includes a male element, a female element or a hooked structure.

3. An assembly according to one of claims 1 or 2, characterised by the fact that the support backing-strip (220) and the closure element (240) are co-extruded.

4. An assembly according to one of claims 1 to 3, characterised by the fact that the support backing-strip (220) and the closure element (240) are co-extruded in different materials.

5. An assembly according to one of claims 1 to 4, characterised by the fact that the support backing-strip (220) and the closure element (240) are co-extruded in materials of different colour.

6. An assembly according to one of claims 1 to 5, characterised by the fact that the support backing-strip (220) and the closure element (240) are co-extruded in materials of different flexibility.

7. An assembly according to one of claims 1 to 6, characterised by the fact that the support backing-strip (220) and the closure element (240) are chosen from the group that includes polyethylene, polypropylene and polystyrene.

8. An assembly according to one of claims 1 to 7, characterised by the fact that the support backing-strip (220) and the closure element (240) are chosen from amongst the pairs of materials formed from polyethylene and polypropylene or polyethylene and polystyrene.

9. An assembly according to one of claims 1 to 8, characterised by the fact that it constitutes an independent closure resource intended to be assembled to, and fixed onto a film.

10. A closure assembly according to one of claims 1 to 8, characterised by the fact that it is integrated into a film during manufacture.

11. An assembly according to one of claims 1 to 10, characterised by the fact that the soleplate (246) is symmetrical in relation to a rod (244) bearing a closure element (242).

12. An assembly according to one of claims 1 to 10, characterised by the fact that the soleplate (246) is asymmetrical in relation to a rod (244) bearing a closure element (242).

13. An assembly according to one of claims 1 to 12, characterised by the fact that the support backing-strip (220) has a variable thickness at the location of the soleplate (246).

14. An assembly according to claim 13, characterised by the fact that the support backing-strip (220) has an increasing thickness close to the rod (244) of the closure element (240).

15. An assembly according to one of claims 1 to 14, characterised by the fact that it includes structures of complementary shape interleaved into the support backing-strip (220) and the complementary soleplate (246).

16. An assembly according to claim 15, characterised by the fact that the support backing-strip (220) includes at least one low ridge (222) engaged in a complementary channel (247) of the soleplate (246).

17. An assembly according to one of claims 15 or 16, characterised by the fact that the support backing-strip (220) includes two low ridges (222) adjacent to the rod (244) of the closure element, engages in complementary channels (247) formed in the soleplate (246).

18. An assembly according to one of claims 1 to 17, characterised by the fact that the soleplate (246) is accessible on the face (224) of the support backing-strip (220) opposite to the face (225) of the support backing-strip (220) by which the closure element (242) emerges.

19. An assembly according to claim 18, characterised by the fact that the support backing-strip (220) at least partially covers the soleplate (246) on the face (224) opposite to that by which the closure element (242) emerges.

20. An assembly according to one of claims 1 to 19, characterised by the fact that the support backing-strip (220) bears several closure elements (240) respectively with a widened soleplate (246).
